(19) United States
(12) Patent Application Publication
(10) Pub. No.: US 2009/0296252 A1
(43) Pub. Date: Dec. 3, 2009

(54) CONTROL APPARATUS, STORAGE DEVICE, AND SYSTEM-INFORMATION STORAGE METHOD

(75) Inventors: Yuji Karakawa, Kawasaki (JP); Hidekazu Masuyama, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/350,766

(22) Filed: Jan. 8, 2009

(30) Foreign Application Priority Data
May 28, 2008 (JP) 2008-140043

(51) Int. Cl. G11B 27/36; G11B 21/02

(52) U.S. Cl. 360/31; 360/75; G9B/27.052; G9B/21.008

(57) ABSTRACT

A magnetic disk device performs test write before storing system information to check the state of each head. The magnetic disk device then stores test write results in a test-write-result table of a RAM. The magnetic disk device then determines whether the number of defective heads is equal to or greater than a predetermined number. When the number of defective heads is equal to or greater than the predetermined number, the magnetic disk device suspends the process of storing the system information. When the number of defective heads is less than the predetermined number, the magnetic disk device refers to the test write results stored in the test-write-result table and performs write only with a head determined as normal.

### CROSS-REFERENCE TO RELATED APPLICATIONS

This application is based upon and claims the benefit of priority of the prior Japanese Patent Application No. 2008-140043, filed on May 28, 2008, the entire contents of which are incorporated herein by reference.

### BACKGROUND

1. Field

The present invention relates to a control apparatus, a storage device, and a system-information storage method for storing system information in a storage medium with a head.

2. Description of the Related Art

In general, a storage device stores system information in a specific area. Examples of the system information include control data for controlling the operation of the device (e.g., defect data and mode parameters) and log data indicative of previous operations (e.g., statistical information about the number of reads/writes and error details). Reference may be had to Japanese Laid-open Patent Publication No. 2006-48789. Although stored at various timings, for example, the system information is stored when an event, such as an error or receipt of Reset, occurs as is the case of log data.

For example, when an A command is issued from a host, a magnetic disk device analyzes the A command. As a result of analysis, when an error is detected in the A command, the magnetic disk device notifies the host of the error, then writes the content of the error to a medium as system information, and stores data (see FIG. 8).

At the time of storing the system information, when in a state where a write error is likely to occur (e.g., when the magnetic disk is vibrating), the magnetic disk device retries writing attempts, and thus takes more time than in a normal state.

Besides, the system information is data that influences the operation of the device and is therefore important. Accordingly, for increasing reliability, the magnetic disk device stores the same data in a multiple manner in several locations (e.g., all heads). This multiple storage can cause a time delay.

As described above, in the conventional technology, when in a state where a write error is likely to occur (e.g., when the magnetic disk is vibrating) upon storing the system information, the magnetic disk device retries writing attempts, and thus takes more time than in a normal state.

As a result, even when the host issues a command, the magnetic disk device cannot execute the command, and the host detects a timeout (see FIG. 9). That is, a timeout occurs due to a cause unknown to a host side.

### SUMMARY

It is an object of the present invention to at least partially solve the problems in the conventional technology.

According to an aspect of an embodiment, a control apparatus includes: a head test unit that performs, before system information is stored in a storage medium of a storage device, a test to check whether heads of the storage device have a defect; and a system-information storing unit that stores the system information with, among the heads, a head determined as normal based on a result of the test by the head test unit.

According to another aspect of an embodiment, a storage device includes: a head test unit that performs, before system information is stored in a storage medium, a test to check whether heads have a defect; and a system-information storing unit that stores the system information with, among the heads, a head determined as normal based on a result of the test by the head test unit.

According to still another aspect of an embodiment, a system-information storage method includes: performing, before system information is stored in a storage medium, a test to check whether heads have a defect; and storing the system information with, among the heads, a head determined as normal based on a result of the test.

Additional objects and advantages of the invention (embodiment) will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

FIG. 1 is a block diagram of a magnetic disk device according to an embodiment;

FIG. 2 is a diagram of an example of a test-write-result table;

FIGS. 3 and 4 are schematic diagrams for explaining a system-information storage process;

FIGS. 5 and 6 are schematic diagrams for explaining a defect-data updating process;

FIG. 7 is a flowchart of the system-information storage process performed by the magnetic disk device according to the embodiment;

FIGS. 8 and 9 are schematic diagrams for explaining a conventional technology.

### DETAILED DESCRIPTION OF THE PREFERRED EMBODIMENTS

Exemplary embodiments of the present invention are described in detail below with reference to the accompanying drawings.

Described below is the configuration of a magnetic disk device according to an embodiment and the operation thereof. Although a magnetic disk device is described below as an example of a storage device, the present invention can be applied to other storage devices than the magnetic disk device, such as a magneto-optical disk.

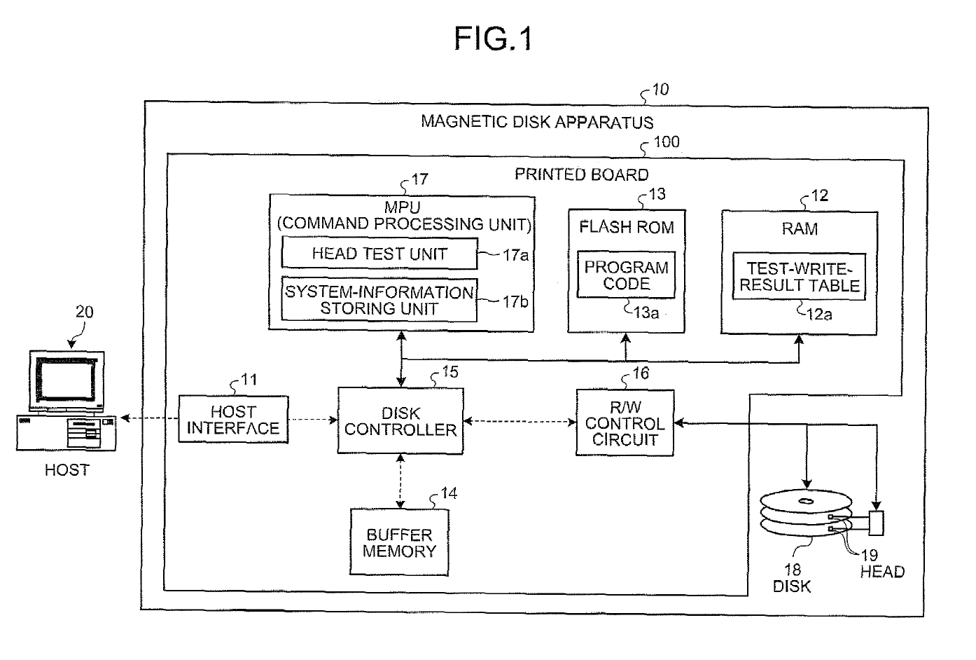

With reference to FIG. 1, the configuration of a magnetic disk device 10 according to an embodiment is explained. FIG. 1 is a block diagram of the magnetic disk device 10. As depicted in FIG. 1, the magnetic disk device 10 includes a printed board 100, disks 18, and heads 19, and is connected to a host 20. The operation of each of these components is explained below.

The disks 18 are a plurality of magnetic disks for recording various data and position control information. In the disks 18, a predetermined area is set as a test cylinder. On the test cylinder, a head test unit 17a, which will be described later, performs test write, thereby checking each header.

Each of the heads 19 has incorporated therein an electrical-magnetic converting element formed of a read element and a write element, and performs reading and writing various data and position control information from and to the disks 18.

The printed board 100 has a host interface 11, a Random Access Memory (RAM) 12, a Flash Read Only Memory (ROM) 13, a buffer memory 14, a disk controller 15, a Read/Write (R/W) control circuit 16, and a Micro processing Unit (MPU) (command processing unit) 17.

The host interface 11 controls communication regarding various information exchanged with the connected host 20. Specifically, the host interface 11 receives an obtained command from the host 20, and transmits the process result and an error report to the host 20.

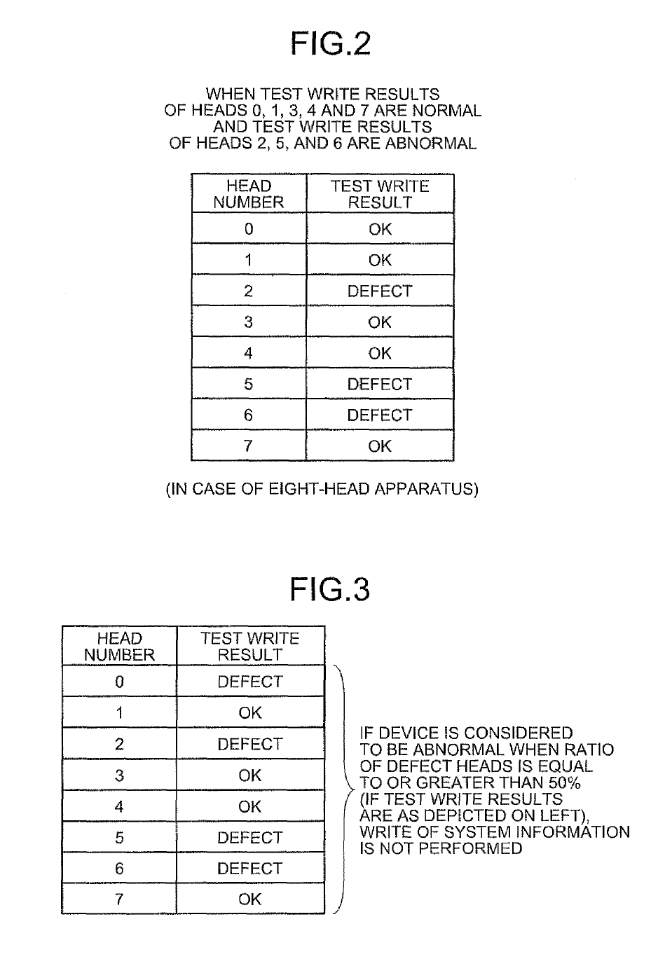

The RAM 12 stores a test-write-result table 12a. The test-write-result table 12a stores the results of a test performed by the head test unit 17a, which will be described later. Specifically, as exemplified in FIG. 2, the test-write-result table 12a stores “head number” that uniquely identifies each head and “test write result” representing results of test write in association with each other.

The Flash ROM 13 stores data and programs required for various processes by the MPU 17 and, in particular, stores program codes 13a. The program codes 13a form a program required for various processes, and are read by the MPU 17, which will be described later. The buffer memory 14 is a cache that temporarily stores data to be read or written between the host 20 and the disks 18.

The disk controller 15 notifies the R/W control circuit 16 of a read/write control signal based on a command reported from the host 20. The disk controller 15 stores recording information read from the disks 18 in the buffer memory 14, and then transmits the information to the host 20 via the host interface 11. The R/W control circuit 16 performs a read/write process on the disks 18 based on the read/write control signal reported from the disk controller 15.

The MPU (command processing unit) 17 has an internal memory for storing programs defining various process procedures and necessary data, and performs various processes based on these programs and data. The MPU 17 includes the head test unit 17a and a system-information storing unit 17b.

The head test unit 17a checks the state of each head before the system information is stored. Specifically, when an event that starts or triggers a system-information storage process (e.g., an error or receipt of Reset) occurs, before the system information is stored, the head test unit 17a performs test write on the test cylinder to check the state of each head. The head test unit 17a then stores the test results in the test-write-result table 12a of the RAM 12.

Since it should not take time to perform such test write, a timer monitors the time to prevent a timeout. Also provided is a function of suspending the test write after a predetermined time. Besides, in a test sense, conditions for the number of retries is restrictively set to be smaller than normal settings.

Based on the test write results stored in the test-write-result table 12a, the system-information storing unit 17b uses a head in a state determined as being normal to store the system information. Specifically, the system-information storing unit 17b determines whether the system information to be stored is important data (e.g., defect data).

The term “defect data” as used herein refers to control information for use in reading sector data. If the defect data is not stored (updated), a wrong sector is read. In other words, the defect data is system information that is stored to perform correct read.

When it is determined that the system information to be stored is not defect data, the system-information storing unit 17b determines whether the number of defect or faulty heads is equal to or greater than a predetermined number. When it is determined that the number of defective heads is equal to or greater than a predetermined number, the system-information storing unit 17b suspends the process of storing the system information.

For example, as depicted in FIG. 3, the system-information storing unit 17b determines, based on the test write results stored in the test-write-result table 12a, whether the ratio of defective heads (indicated as “DEFECT” by the test write result) is equal to or greater than 50% (in the example of FIG. 3, whether the number of defective heads is equal to or greater than four). When the ratio of defective heads is equal to or greater than 50%, the system-information storing unit 17b does not write the system information.

That is, when the number of defective heads is equal to or greater than the predetermined number, there is a high possibility that the magnetic disk device itself has some failure. In such a state, even if the system information is tried to be written, there is a high possibility that such write fails. Thus, based on the test write results, if the number of defective heads exceeds the predetermined number, the system information is not stored.

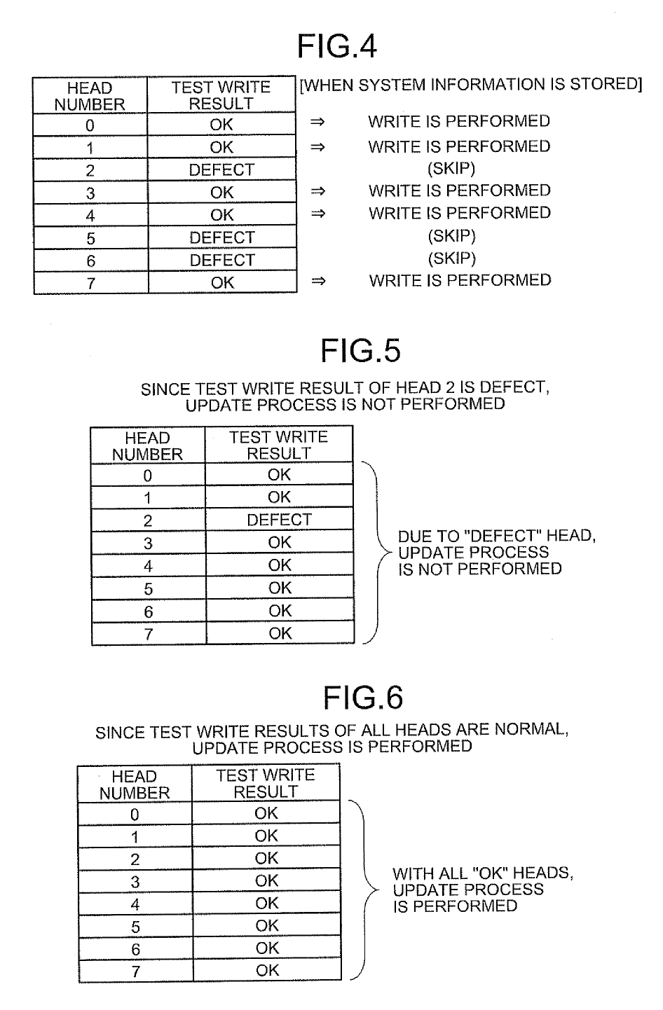

If the number of defective heads is less than the predetermined number, as depicted in FIG. 4, the system-information storing unit 17b refers to the test write results stored in the test-write-result table 12a to write the system information only with heads determined as being normal (OK). Then, regarding heads determined as defective, the system-information storing unit 17b skips writing.

That is, since the system information is data influencing the operation of the apparatus and is important, the same data is stored in several locations (all heads) in a multiple manner for improving reliability. Therefore, it is possible to skip some of multiple writes and decrease multiplicity. Thus, by referring to the test write results, write is performed only with the heads recorded as being normal (OK), and write is not performed as being skipped for those recorded as defective.

On the other hand, when it is determined that the system information to be stored is defect data, the system-information storing unit 17b determines whether all heads are normal. When it is determined as depicted in FIG. 5 that all heads are not normal, the system-information storing unit 17b does not store (update) the system information.

As depicted in FIG. 6, if all heads are normal, the system-information storing unit 17b stores (updates) the system information with all normal heads. That is, the defect data is control information for use in reading sector data, and is also system information that needs to be appropriately stored because correct read cannot be made when the original data is destroyed with erroneous update. For such system information, in consideration of the case where even all writes with the heads recorded as being normal (OK) result in write errors, the storage process is skipped.

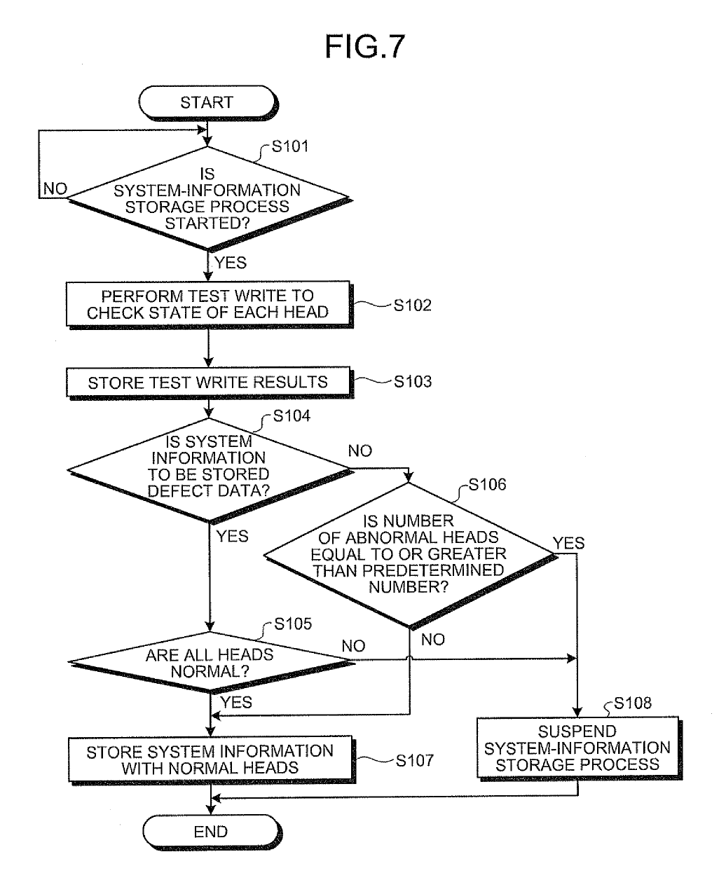

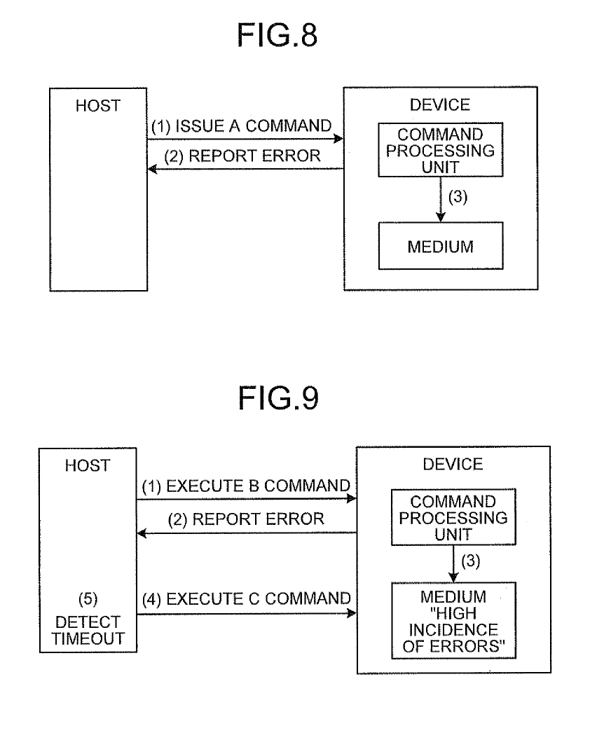

Next, with reference to FIG. 7, the operation of the magnetic disk device 10 according to the embodiment is explained. FIG. 7 is a flowchart of a system-information storage process performed by the magnetic disk device 10 according to the embodiment.

As depicted in FIG. 7, when an event starting a system-information storage process occurs (Yes at Step S101), before storing the system information, the magnetic disk device 10 performs test write to check the state of each head (Step S102). The magnetic disk device 10 then stores the test results in the test-write-result table 12a of the RAM 12 (Step S103).

The magnetic disk device 10 then determines whether the system information to be stored is important data such as defect data (Step S104). When it is determined that the system information to be stored is not defect data (No at Step S104), the magnetic disk device 10 determines whether the number of defective heads is equal to or greater than a predetermined number (Step S106).

When it is determined that the number of defective heads is equal to or greater than a predetermined number (Yes at Step S106), the magnetic disk device 10 suspends the system-information storage process (Step S108). When it is determined that the number of defective heads is not equal to or greater than a predetermined number (No at Step S106), the magnetic disk device 10 refers to the test write results stored in the test-write-result table 12a to perform a write only with the heads recorded as being normal (OK) (Step S107).

When it is determined at step S104 that the system information to be stored is defect data (Yes at Step S104), the magnetic disk device 10 determines whether all heads are normal (Step S105).

When all heads are not normal (No at Step S105), the magnetic disk device 10 suspends the process of storing (updating) the system information (Step S108). When all heads are normal (Yes at Step S105), the magnetic disk device 10 stores (updates) the system information with all normal heads (Step S107).

As explained above, according to the embodiment, the magnetic disk device 10 performs a test to check whether the heads 19 has a defect before storing the system information in the disks 18. Then, based on the results of the test on the heads 19, the heads 19 in a state determined as being normal are used to store the system information. Thus, the system information is stored with only the normal heads with a good test write result. As a result, delay in storing the system information can be suppressed. In addition, the occurrence of a timeout due to a cause unknown to a host side can be prevented.

Moreover, the magnetic disk device 10 checks whether the heads 19 has a defect immediately after the occurrence of an event that starts or triggers a system-information storage process. Thus, it is possible to accurately obtain a write enable/disable state of the heads 19.

Furthermore, the magnetic disk device 10 determines whether the number of heads determined as defective is equal to or greater than a predetermined number. When the number of heads determined as defective is equal to or greater than the predetermined number, the magnetic disk device 10 suspends the process of storing the system information. That is, when the number of defective heads exceeds the predetermined number, there is a high possibility that the magnetic disk device 10 itself has some failure. In such a state, even if the system information is tried to be written, there is a high possibility that such write fails. Thus, with the system information being not stored, a write error can be prevented.

Still further, when the system information to be stored is important information and when it is determined, based on the results of test write on the heads 19a, that all heads 19 are not normal, the magnetic disk device 10 suspends the process of storing the system information. As a result, it is possible to prevent a write error for important system information.

While an embodiment of the present invention has been described and illustrated, the present invention is not limited to the embodiment but is capable of numerous rearrangements, modifications and substitutions of parts and elements.

For example, in the above embodiment, test write is described as being performed when an event that starts or triggers a system-information storage process (e.g., an error or receipt of Reset) occurs. Alternatively, test write may be performed at predetermined time intervals or regularly to check the state of each head. Specifically, the magnetic disk device performs test write for each head between command processes in a patrol manner. When storing the system information, the magnetic disk device uses a head in a state determined as normal based on the results of immediately-preceding test write.

In this case, whether the state of each head is abnormal is checked at predetermined time intervals, i.e., test write is performed for each head between command processes. As a result, overhead due to a test information write can be suppressed to the minimum.

The constituent elements of the magnetic disk device described above are functionally conceptual, and need not be physically configured as illustrated. In other words, the specific mode of dispersion and integration of the constituent elements is not limited to the ones illustrated in the drawings, and the constituent elements, as a whole or in part, can be divided or integrated either functionally or physically based on various types of loads or use conditions. All or any part of the processing functions performed by the device or the units can be realized by a Memory Control Unit (MCU) or a control apparatus such as a Central Processing Unit (CPU) or a Micro Processing Unit (MPU) and a program analyzed and executed by the MCU or the control apparatus, or can be realized as hardware by wired logic.

As set forth hereinabove, according to an embodiment of the present invention, it is possible to prevent the occurrence of a timeout due to a cause unknown to a host side as well as to suppress delay in storing system information.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A control apparatus comprising:
a head test unit that performs, before system information is stored in a storage medium of a storage device, a test to check whether heads of the storage device have a defect; and
a system-information storing unit that stores the system information with, among the heads, a head determined as normal based on a result of the test by the head test unit.

2. The control apparatus according to claim 1, wherein the head test unit performs the test immediately after an event that triggers a process of storing the system information occurs and before the system information is stored.

3. The control apparatus according to claim 1, wherein
the head test unit performs the test at predetermined time intervals, and
the system-information storing unit stores the system information with a head determined as normal based on a result of an immediately-preceding test by the head test unit.

4. The control apparatus according to claim 1, wherein the system-information storing unit determines whether number of heads determined as defective is equal to or greater than a predetermined number based on the result of the test, and, when the number of heads determined as defective is equal to or greater than the predetermined number, suspends a process of storing the system information.

5. The control apparatus according to claim 1, wherein when the system information to be stored is specific information and all the heads are not determined as normal, the system-information storing unit suspends a process of storing the system information.

6. A storage device comprising:
a head test unit that performs, before system information is stored in a storage medium, a test to check whether heads have a defect; and
a system-information storing unit that stores the system information with, among the heads, a head determined as normal based on a result of the test by the head test unit.

7. A system-information storage method comprising:
performing, before system information is stored in a storage medium, a test to check whether heads have a defect; and
storing the system information with, among the heads, a head determined as normal based on a result of the test.
